(19) United States
(12) Patent Application Publication
(10) Pub. No.: US 2026/0138701 A1
(43) Pub. Date: May 21, 2026

(54) INVERTED SUSPENSION FORK WITH AIR SPRING ASSEMBLY

(71) Applicant: Fox Factory, Inc., Duluth, GA (US)

(72) Inventors: William M. Becker, Aptos, CA (US); Damon Gilbert, Aptos, CA (US)

(21) Appl. No.: 19/226,990

(22) Filed: Jun. 3, 2025

Related U.S. Application Data
(60) Provisional application No. 63/720,875, filed on Nov. 15, 2024.

(51) Int. Cl. B62K 25/06

(52) U.S. Cl. CPC B62K 25/06

(57) ABSTRACT

A suspension system includes an upper tube, a lower tube slidably engaged with the upper tube, and an air spring assembly disposed within the lower tube. The air spring assembly comprises an air piston positioned within a cylinder configured to retain an amount of bath oil, an air inlet positioned on a lower end of the cylinder, an extension tube in communication with the air inlet, and an air exit aperture positioned on the extension tube at a location above a maximum fill amount of the bath oil. The suspension system provides improved air spring performance and lubrication in an inverted fork configuration.

### CROSS-REFERENCE TO RELATED APPLICATION

This application claims the benefit of and priority to U.S. Provisional Patent Application No. 63/720,875 filed Nov. 15, 2024, entitled “Inverted Suspension Fork with Improved Air Spring and Lubrication,” the contents of which being incorporated by reference in their entirety herein.

### TECHNICAL FIELD

The present disclosure relates generally to suspension systems for vehicles, and more particularly to suspension forks with air spring assemblies for bicycles and other two-wheeled or multi-wheeled vehicles.

### BACKGROUND

Suspension forks are widely used in bicycles, motorcycles, and other vehicles to absorb shocks and vibrations from uneven terrain, improving rider comfort and vehicle control. Inverted suspension forks, where smaller diameter lower tubes slide into larger diameter upper tubes, offer potential advantages in terms of rigidity and responsiveness. However, existing inverted fork designs often face challenges related to air spring performance, bottom-out protection, and efficient lubrication of internal components.

As riders continue to push the limits of their vehicles in increasingly demanding conditions, there is an ongoing need for improved suspension fork designs that address these challenges while maintaining or enhancing overall performance. Factors such as air spring characteristics, negative spring volume, bottom-out protection, and internal lubrication can impact ride quality, durability, and maintenance requirements. Advancements in these areas may contribute to enhanced riding experiences across a range of vehicle applications.

### BRIEF SUMMARY

Various embodiments are disclosed for an inverted suspension fork having an air spring assembly. According to an aspect of the present disclosure, an inverted suspension fork for a vehicle is provided. The inverted suspension fork includes a first upper tube and a second upper tube. The inverted suspension fork also includes a first lower tube slidably engaged with the first upper tube and a second lower tube slidably engaged with the second upper tube. The inverted suspension fork further includes an air spring assembly disposed within one of the first lower tube and the second lower tube. The air spring assembly comprises a piston, an air inlet positioned on a lower end of the lower tube, an extension tube in communication with the air inlet, and at least one air exit aperture positioned in an upper end of the extension tube.

The at least one air exit aperture may be cross-drilled substantially perpendicular to a longitudinal axis of the extension tube. The inverted suspension fork may further comprise bath oil positioned within at least one of the first lower tube and the second lower tube, wherein the air exit aperture is positioned above the bath oil. The at least one air exit aperture may be positioned at a top surface of the extension tube along a longitudinal axis of the extension tube.

The inverted suspension fork may further comprise at least one volume spacer having an aperture, the extension tube being positioned through the aperture. The at least one air exit aperture may be positioned in the annular wall of the extension tube. The at least one volume spacer may comprise a friction device positioned around the aperture that forms a friction connection with the extension tube. The at least one volume spacer may comprise an inner diameter configured to provide an interference fit between the at least one volume spacer and the extension tube.

According to another aspect of the present disclosure, a suspension system is provided. The suspension system includes an upper tube and a lower tube slidably engaged with the upper tube configured to contain bath oil. The suspension system also includes an air spring assembly disposed within the lower tube. The air spring assembly comprises an air piston, an air inlet positioned on a lower end of the lower tube, an extension tube in communication with the air inlet, and at least one air exit aperture positioned on the extension tube at a location above a maximum fill amount of the bath oil.

The suspension system may further comprise at least one volume spacer sized and positioned to closely conform to inner surfaces of the lower tube, the volume spacer having an aperture, the extension tube being positioned through the aperture. The suspension system may further comprise at least one volume spacer comprising a friction device positioned around the aperture that forms a friction connection with the extension tube.

The at least one air exit aperture of the extension tube may be positioned in the annular wall of the extension tube. The at least one air exit aperture of the extension tube may be positioned substantially perpendicular to a longitudinal axis of the extension tube. The at least one air exit aperture of the extension tube may be positioned at a top surface of the extension tube along a longitudinal axis of the extension tube. The suspension system may further comprise a friction device positioned on an upper end of extension tube, the friction device being configured to retain the at least one volume spacer on the extension tube. The upper tube and the lower tube may be part of an inverted fork for a vehicle.

According to another aspect of the present disclosure, a suspension system is provided. The suspension system includes an upper tube and a lower tube slidably engaged with the upper tube, the lower tube comprising bath oil or being configured to retain bath oil. The suspension system also includes an air spring assembly disposed within the lower tube. The air spring assembly comprises an air piston defining a positive air chamber and a negative air chamber, an air inlet positioned on a lower end of the lower tube, and an extension tube comprising at least one air exit aperture. The extension tube is in communication with the air inlet and with the positive air chamber. The air exit aperture is configured to reduce a loss of the bath oil from the lower tube through the extension tube.

The extension tube may comprise at least one air exit aperture positioned at a location above a maximum fill amount of the bath oil. At least one air exit aperture may be formed in the annular wall of the extension tube. The suspension system may further comprise at least one volume spacer comprising an aperture, where the extension tube is positioned within the aperture.
This summary is provided to introduce a selection of concepts in a simplified form that are further described below in the detailed description. The summary is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a front view of an inverted suspension fork according to various embodiments of the present disclosure.

FIG. 2 is a front view of the inverted suspension fork of FIG. 1 shown in full compression according to various embodiments of the present disclosure.

FIG. 3 is a front view of the inverted suspension fork of FIG. 1 in full extension according to various embodiments of the present disclosure.

FIG. 4 is a cross-sectional view of the inverted suspension fork of FIG. 1 according to various embodiments of the present disclosure.

FIG. 5 is an enlarged cross-sectional view of a positive main air cylinder of the inverted suspension fork according to various embodiments of the present disclosure.

FIG. 6 is another enlarged cross-sectional view of a positive main air cylinder of the inverted suspension fork according to various embodiments of the present disclosure.

### DETAILED DESCRIPTION

The present disclosure relates to an inverted suspension fork having an air spring assembly. Suspension forks are used in various two and three-wheeled vehicles, such as bicycles and motorcycles, to absorb shocks and vibrations from uneven terrain and dynamic movements, improving rider comfort and vehicle control. Inverted suspension forks, where smaller diameter lower tubes slide into larger diameter upper tubes, offer advantages in terms of rigidity and responsiveness. However, existing inverted fork designs often face challenges related to air spring performance, bottom-out protection, and efficient lubrication of internal components. These issues can impact ride quality, durability, and maintenance requirements.

In some instances, existing air spring assembly designs in inverted suspension forks do not provide optimal performance throughout the travel range. Negative air spring volume, which affects initial sensitivity and small bump compliance, may be limited in some designs. This can result in undesirable ride quality, particularly at the beginning of travel of the suspension fork. Bottom-out protection designs also face challenges. For instance, bottom-out bumpers are prone to deformation or displacement, potentially leading to metal-to-metal contact during deep compression events. This can negatively impact durability, longevity, and performance of a suspension fork.

Efficient lubrication of internal components is a common challenge in inverted suspension fork designs. The inverted orientation can make it difficult to maintain consistent lubrication of sliding surfaces and air seals, possibly leading to increased friction and reduced performance over time. It is desirable to have a sufficient amount of bath oil in the fork such that agitation during operation of the vehicle causes components of the suspension to remain lubricated.

As riders continue to push the limits of their vehicles in increasingly demanding conditions, there is an ongoing need for improved suspension fork designs that address these challenges while maintaining or enhancing overall performance. Innovations in air spring design, bottom-out protection systems, and lubrication methods may help overcome these limitations and provide enhanced riding experiences across a range of vehicle applications.

Accordingly, various embodiments are disclosed herein for a suspension system for vehicles that includes a suspension fork and, in some embodiments, an inverted suspension fork. A suspension fork may include upper tubes and lower tubes that are slidably engaged with each other. An air spring assembly may be disposed within tubes on one side of a suspension fork in conjunction with a damper assembly positioned in an opposing side of the suspension fork.

In some embodiments, the air spring assembly may include an air piston positioned within a cylinder or a chamber defined by inner walls of the tubes. An air inlet may be positioned on a lower end of the cylinder. The air spring assembly may further include an extension tube in communication with the air inlet. Further, an air exit aperture may be positioned in an upper end of the extension tube. The air exit aperture may be oriented perpendicular to a longitudinal axis of the extension tube. This configuration may allow for improved air flow within the system while preventing bath oil from entering a hollow interior of the extension tube.

The suspension system may also include one or more volume spacers. In some implementations, the volume spacer may have an aperture through which the extension tube is positioned. This arrangement may allow for adjustable air volume within the system. Riders or other operators can selectively remove or add volume spacers to customize performance of the suspension fork.

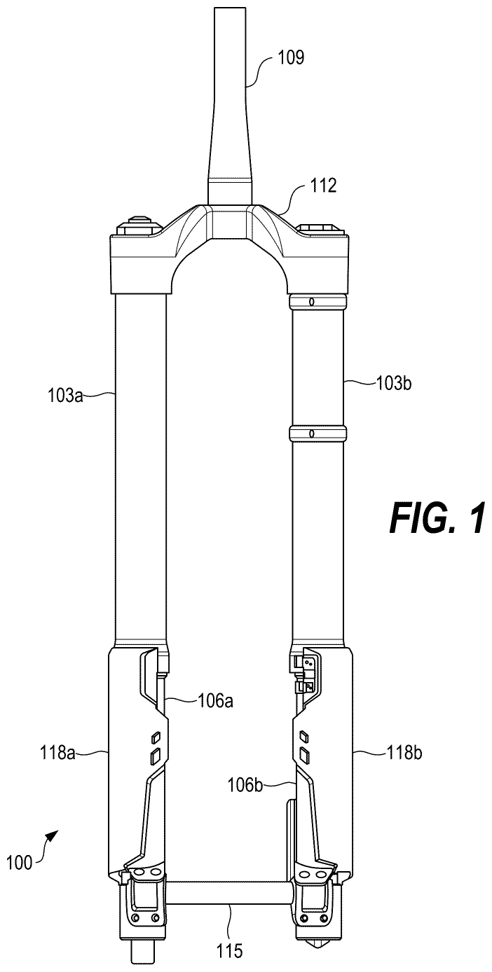

Turning now to the figures, FIGS. 1, 2, and 3 show front views of a suspension system according to various embodiments. The suspension system includes an inverted suspension fork 100. While an inverted-type of suspension fork is described in various embodiments, it is understood that the components and functions described herein can also be implemented with other types of suspension forks (e.g., non-inverted suspension forks) and suspension systems without deviating from the principles of the disclosure.

Referring among FIGS. 1-3, the inverted suspension fork 100 includes upper tubes 103a, 103b (collectively “upper tubes 103”) and lower tubes 106a, 106b (collectively “lower tubes 106”). As such, a first lower tube 106a is slidably engaged with a first upper tube 103a, and a second lower tube 106b is slidably engaged with a second upper tube 103b, as can be appreciated. To this end, the upper tubes 103 can have a diameter larger than a diameter of the lower tubes 106.

The slidable engagement between the upper tubes 103 and lower tubes 106 allows for compression and extension of the inverted suspension fork 100 as a rider traverses various terrains on a bicycle or similar vehicle. When the rider encounters bumps, obstacles, or uneven surfaces, the lower tubes 106 may telescope into the upper tubes 103, absorbing shock and vibration. This movement helps to maintain tire contact with the ground, improving traction and control. As the inverted suspension fork 100 rebounds after compression, the lower tubes 106 extend back out from the upper tubes 103, preparing the suspension for the next impact. The sliding action between the upper tubes 103 and the lower tubes 106 may be facilitated by bushings, seals, and lubricating oil, which work together to reduce friction and ensure consistent performance throughout the travel range of the inverted suspension fork 100.

The inverted suspension fork 100 further includes a steerer tube 109, a crown 112, and a through-axle 115. The crown 112 can couple the upper tubes 103 to one another, and the through-axle 115 can couple the lower tubes 106 to one another. The steerer tube 109 and the crown 112 can collectively form a crown-steerer assembly, and the steerer tube 109 can extend vertically from a central portion of the crown 112. The upper tubes 103 can be assembled by press-fit or pinch-bolts to the crown-steerer assembly. The inverted suspension fork 100 can be fastened to the headtube of a bicycle, motorcycle, or other two-or three-wheeled vehicle through a set of headset bearings internal to the steerer tube 109 and steered by a bolt-on stem-handlebar assembly. This configuration can provide a secure connection between the inverted suspension fork 100 and a frame of a vehicle while allowing for smooth steering control.

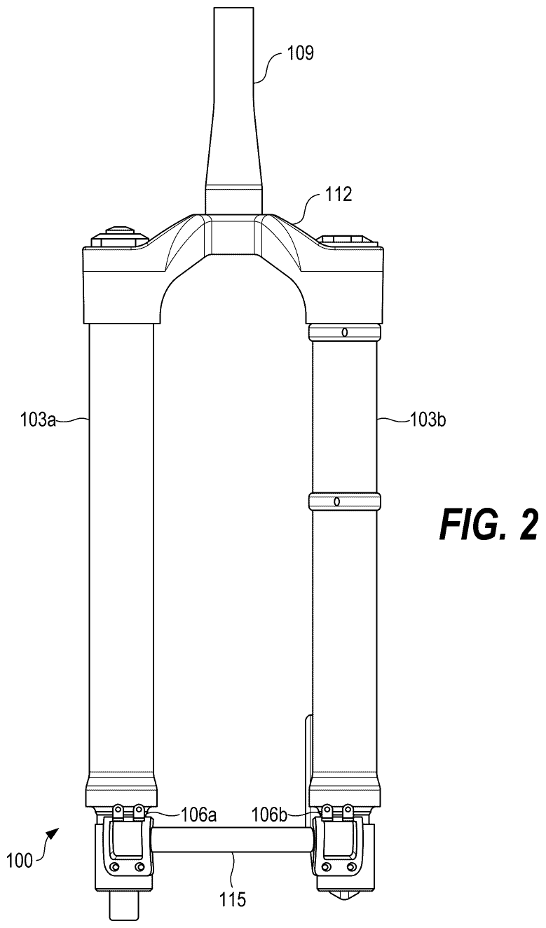

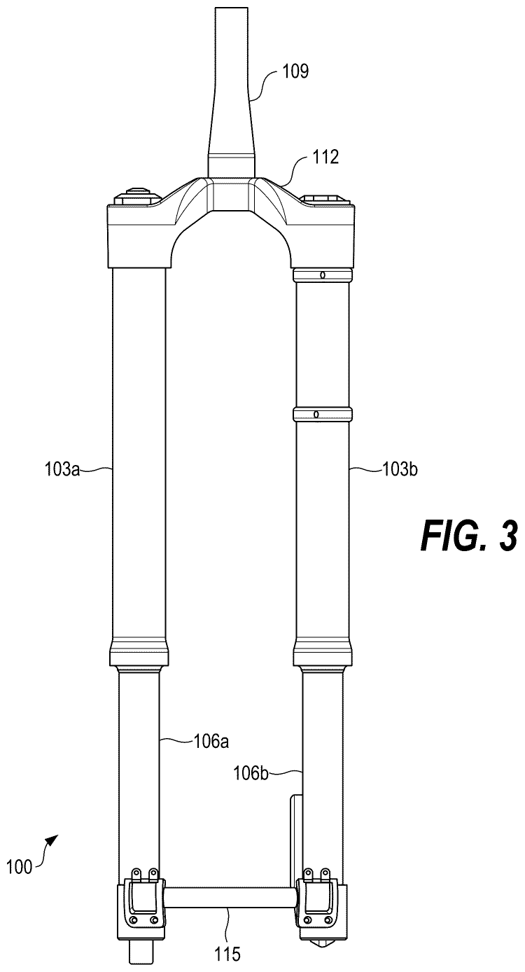

The through-axle 115 can be used to secure the inverted suspension fork 100 to a vehicle. For example, the through-axle 115 can be passed through a hub of a wheel of a vehicle including, but not limited to, a front wheel of a bicycle or motorcycle. In FIG. 1, the inverted suspension fork 100 includes lower guards 118a, 118b (collectively “lower guards 118”) that cover the lower tubes 106, protecting the lower tubes 106 from debris, impact, and other degrading forces. The lower guards 118 are omitted from view in FIGS. 2 and 3 for explanatory purposes, however. The lower guards 118 can be detachably attachable to the inverted suspension fork 100 in some embodiments, or can be integral with the upper tubes 103.

The steerer tube 109, upper tubes 103, and lower tubes 106 of the inverted suspension fork 100 can be constructed from a variety of materials selected to provide an optimal balance of strength, weight, and performance characteristics. In some implementations, these components, among other components of the inverted suspension fork 100, can be fabricated from high-strength aluminum alloys, which offer excellent stiffness-to-weight ratios and corrosion resistance. Carbon fiber composites can also be utilized, particularly for the steerer tube 109 and upper tubes 103, to further reduce weight while maintaining structural integrity. In other cases, the lower tubes 106 can be constructed from steel alloys to enhance durability and withstand the stresses of repeated compression and extension cycles. Titanium alloys may be employed in premium fork designs, offering a combination of low weight, high strength, and vibration damping. The choice of materials for each component can be selected to meet specific performance requirements, rider preferences, and intended use cases of the inverted suspension fork 100.

FIG. 2 shows the inverted suspension fork 100 in full compression representing the maximum travel of the inverted suspension fork 100, where the lower tubes 106 have telescoped fully into the upper tubes 103. During full compression, an air spring assembly, as will be described, is at its maximum pressure, providing the greatest resistance to further compression. Bottom-out bumpers positioned in the upper tubes 103, if present, are contacted by the lower tubes or other components to prevent metal-to-metal contact between the upper tubes 103 and the lower tubes 106. FIG. 2 illustrates an extreme end of the travel range of the inverted suspension fork 100, which typically occurs during significant impacts or landings from large drops.

FIG. 3, on the other hand, shows the inverted suspension fork 100 in full extension or rebound. In this position, the lower tubes 106 are extended to their maximum length from the upper tubes 103, representing an opposite end of the travel range from the full compression shown in FIG. 2. This often occurs when the vehicle is unloaded or when the suspension is rebounding after absorbing an impact. The full extension position shown in FIG. 3 and the full compression position shown in FIG. 2 together illustrate a maximum available travel of the inverted suspension fork 100.

In the fully extended position, an air spring assembly, as will be described, positioned in upper tubes 103 or lower tubes 106 may be at its lowest pressure state. This configuration may allow for maximum sensitivity to small bumps and vibrations at the beginning of travel of the inverted suspension fork 100. The relationship between the upper tubes 103 and lower tubes 106 in this position may also affect initial stiffness and responsiveness of the inverted suspension fork 100.

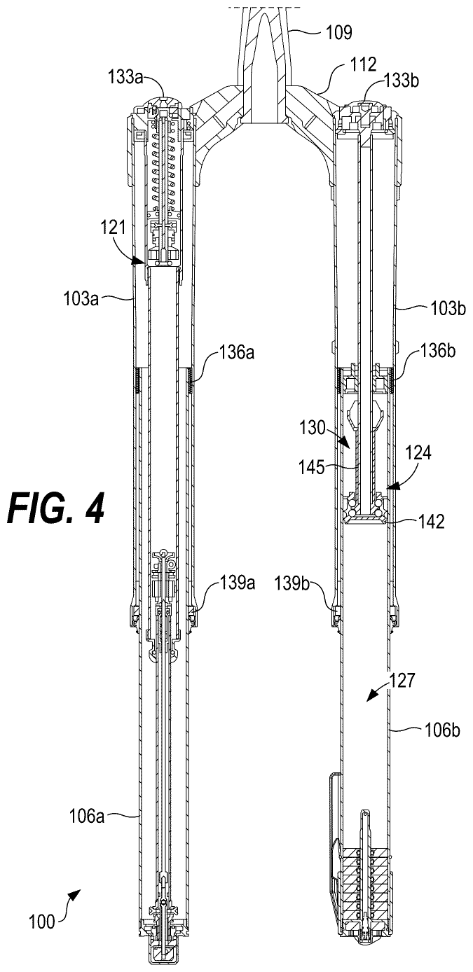

Turning now to FIG. 4, FIG. 4 shows a cross-sectional view of the inverted suspension fork 100 depicting various internal components. The inverted suspension fork 100 can include a damper assembly 121 positioned in the first upper tube 103a and/or the first lower tube 106a, and an air-spring assembly 124 positioned in the second upper tube 103b and/or the second lower tube 106b. In other words, the inverted suspension fork 100 can include a damper assembly 121 positioned in tubes 103a, 106a on a first side of the inverted suspension fork 100, and an air-spring assembly 124 positioned in the tubes 103b, 106b on a second side of the inverted suspension fork 100.

This configuration illustrates a dual-chamber damper and air-spring assembly that can be provided in high-performance inverted suspension forks 100. The damper assembly 121 can be configured to control a rate of compression and rebound of the inverted suspension fork 100, and provide adjustable damping characteristics to suit various riding conditions and preferences. The damper assembly 121 can include, for example, an upper piston, a lower piston, shim stacks, and oil to create hydraulic resistance.

On the other hand, the air-spring assembly 124 is configured to provide a main spring force of the inverted suspension fork 100. The air-spring assembly 124 utilizes compressed air to resist compression and return the inverted suspension fork 100 to its extended position, shown in FIG. 3. To this end, the air-spring assembly 124 includes a positive air chamber 127 and a negative air chamber 130 positioned within inner walls of a cylinder defined by the upper tubes 103b and/or the lower tube 106b. The positive air chamber 127 and the negative air chamber 130 can be adjusted to fine-tune behavior of the inverted suspension fork 100 throughout its travel range. By positioning these assemblies in separate legs of the fork, the design allows for optimal performance of each system without interference, while also distributing the functional components evenly across the inverted suspension fork 100.

The inverted suspension fork 100 can include one or more compression adjusters 133a and top caps 133b. For instance, compression adjuster 133a, positioned on the crown 112 above the first upper tube 103a, can be used to adjust or control desired characteristics of the damper assembly 121. The compression adjuster 133a may provide an interface for riders or vehicle operators to fine-tune the suspension characteristics of the inverted suspension fork 100. In some implementations, compression adjuster 133a may feature a rotatable dial or knob that an operator can manipulate to adjust various suspension parameters. By rotating the dial clockwise or counterclockwise, the operator may increase or decrease compression damping, respectively.

For the compression adjuster 133a associated with the damper assembly 121, the operator may adjust the compression damping to control how quickly the inverted suspension fork 100 compresses under load. A firmer setting achieved by rotating the dial clockwise, for example, may provide more resistance to compression, which can be beneficial for smoother terrain or when the rider desires a more responsive feel. Conversely, a softer setting achieved by rotating the dial counterclockwise, for example, may allow for easier compression, improving small bump sensitivity and traction on rough terrain.

In some embodiments, the compression adjuster 133a includes detents or click positions, providing tactile feedback to the operator and allowing for more precise and repeatable adjustments. Additionally, the adjuster 133a may include visual indicators, such as numbered markings or color-coded zones, which may help riders track and replicate their preferred settings across different riding conditions.

The negative air chamber 130 of the air-spring assembly 124 can be positioned at the top of the tube 106b and the positive air chamber 127 can be positioned at the bottom of the tube 106b. These chambers work in conjunction to provide a balanced and responsive suspension action. The negative air chamber 130 can help to reduce initial breakaway force required to initiate suspension movement, improving small bump sensitivity and providing a desirable feel at the beginning of the travel. As the inverted suspension fork 100 compresses, the positive air chamber 127 can provide increasing resistance, helping to support the operator's weight and prevent bottoming out on larger impacts. The relative volumes and pressures of these chambers can be adjustable, allowing riders to fine-tune the behavior of the inverted suspension fork 100 to suit preferences and riding conditions.

The inverted suspension fork 100 can include various bushings, such as upper bushings 136a, 136b (collectively “upper bushings 136”), lower bushing 139a, 139b (collectively “lower bushings 139”), and so forth. The upper bushings 136 can be positioned near a top of the lower tubes 106, while the lower bushings 139 can be positioned near the bottom of the upper tubes 103. Together, these bushings 136, 139 guide the sliding motion between the upper tubes 103 and the lower tubes 106, reducing friction and ensuring proper alignment throughout the travel range of the inverted suspension fork 100.

The bushings 136, 139 can be made from low-friction materials such as polytetrafluoroethylene (PTFE) or other specialized polymers designed to withstand the dynamic loads and environmental conditions experienced by the inverted suspension fork 100. The bushings 139, 139 cab distribute forces evenly across the sliding surfaces, preventing metal-to-metal contact between the upper tubes 103 and the lower tubes 106, which can reduce wear and extends the life of the inverted suspension fork 100 while also contributing to a smooth and more responsive suspension action.

The air-spring assembly 124 can include an air piston 142 coupled to a shaft 145 which can permit transfer of air pressure between the positive air chamber 127 and the negative air chamber 130. The shaft 145 can be a hollow shaft or a solid shaft. The air piston 142 can translate or otherwise move within the cylinder in response to compression and extension of the inverted suspension fork 100. In some implementations, the shaft 145 may extend from the air piston 142 towards the upper portion of the inverted suspension fork 100, passing through the negative air chamber 130. The air piston 142 and the shaft 145 can include seals (not shown) to maintain proper air pressure separation between chambers and prevent unwanted air loss.

An indented air transfer port (not shown) on the lower tube 106 can facilitate air transfer and filling of air into the negative air chamber. The transfer port can include a bypass indentation formed into the lower tube 106 that is longer than a seal of the air piston 142. When the inverted suspension fork 100 is compressed and passes by the transfer port, the pressure equalizes between the positive air chamber 127 and the negative air chamber 130. An axial positioning of the transfer port can be selected to finalize a stopping point of the air spring assembly when unweighted and sets a maximum travel of the inverted suspension fork 100.

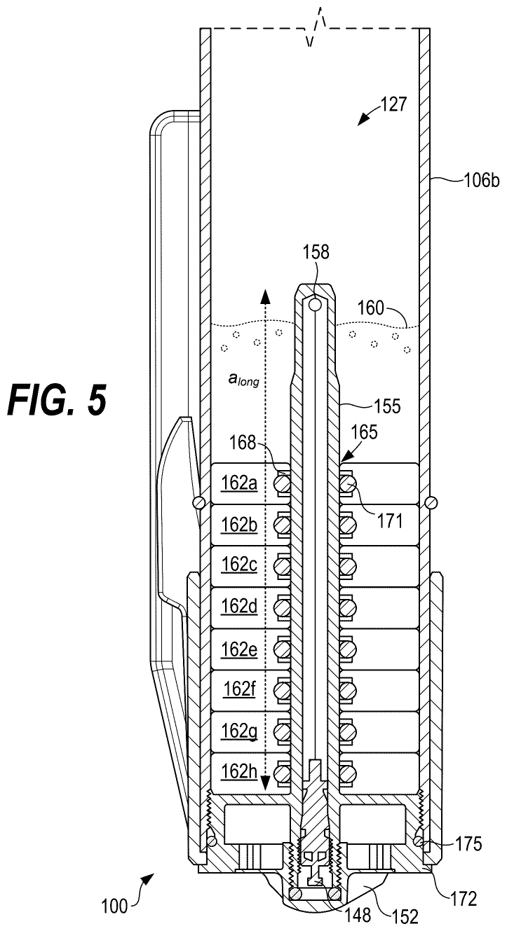

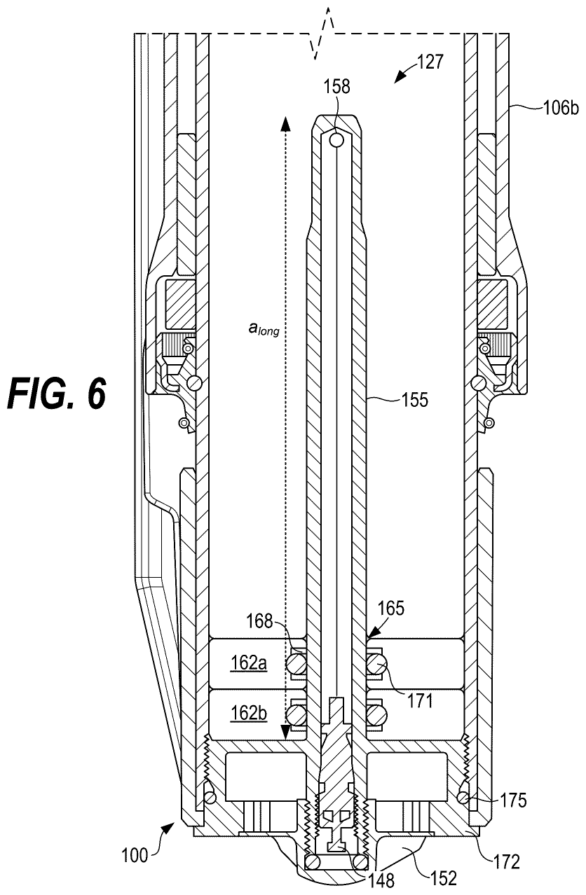

FIGS. 5 and 6 provide enlarged views of the bottom portion of the cylinder (e.g., the lower tube 106b positioned on the right side of the inverted suspension fork 100 shown in FIG. 4). More specifically, a bottom portion of the positive air chamber 127 is shown at a lower end of the cylinder. An air inlet 148 can be positioned on the lower end of the cylinder. The air inlet 148 can include a Schrader valve inlet in some embodiments. In some embodiments, the air inlet can be a different valve, such as a Presta valve, or the like. The air inlet 148 allows for adding or removing air to adjust the spring characteristics. To this end, an air cap 152 detachably attachable to the cylinder can be threaded or otherwise coupled to the air inlet 148 to protect the air inlet 148 during operation. The air cap 152 can be unscrewed or otherwise decoupled to attach an air pump (e.g., a hand-operated air pump) for pressure adjustments.

An extension tube 155 extends upward from the air inlet 148 into the cylinder, where a height of the extension tube 155 prevents oil from draining out of an air valve when air pressure is raised or lowered. The extension tube 155 can be hollow in some embodiments, and thus the extension tube 155 can be in communication with the air inlet 148 to permit the flow of air therethrough. The extension tube 155 can include at least one air exit aperture 158 through which air can exit the extension tube 155 into the positive air chamber 127.

In some embodiments, the at least one air exit aperture 158 is positioned perpendicular to a longitudinal axis a_{long} of the extension tube 155. In some embodiments, at least one air exit aperture 158 is positioned substantially perpendicular to a longitudinal axis a_{long} of the extension tube 155. The at least one air exit aperture 158 can be cross-drilled or otherwise formed to allow air to flow between the positive air chamber 127 and the extension tube 155 while preventing bath oil from entering an interior of the extension tube 155.

In some embodiments, at least one air exit aperture is positioned in the annular wall of the extension tube 155. In some embodiments, the at least one air exit aperture can be positioned along the longitudinal axis a_{long} of the extension tube 155. In some embodiments, at least one air exit aperture can be positioned at the top surface of the extension tube 155 and be oriented along the longitudinal axis a_{long} of the extension tube 155. In some embodiments, there can be more than one air exit aperture formed in the extension tube 155 at any of the foregoing locations.

The cylinder contains a bath oil to lubricate internal components. In some embodiments, approximately 5 cc to 30 cc of oil can be used, such as 5 cc, 12 cc, 15 cc, 20 cc, 25 cc 29, 30 cc, and so forth. In other embodiments, the amount of bath oil that can be used is different and depends on the specific fork model. The oil helps lubricate the interior cylinder wall, air piston seal, and other moving parts. In some implementations, the air exit aperture 158 in the extension tube 155 is positioned above a maximum oil level 160 to prevent oil ingress into an interior of the extension tube 155. Any bath oil that drips back down to an oil reservoir height is less likely to go through the at least one air exit aperture 158 which is located above a maximum oil level 160, and less likely for bath oil to enter a hollow interior of the extension tube 155 or in an air valve coupled thereto.

According to various embodiments, one or more volume spacers 162a . . . 162h (collectively “volume spacers 162”) can be positioned in the cylinder to adjust air spring characteristics of the air-spring assembly 124. For instance, one to eight of the volume spacers 162 can be positioned in the cylinder, although other number of volume spacers 162 can be utilized. In some embodiments, the volume spacers 162 are donut-shaped. In other words, the volume spacers 162 include an annular-shaped body, and further include an annular-shaped aperture positioned therein. The volume spacers 162 thus can include a central aperture 165 through which the extension tube passes.

In some embodiments, the volume spacers 162 can include a retention feature that retains the volume spacers 162 to the extension tube 155. To this end, in some embodiments, the volume spacers 162 include an annular groove 168 having a friction device, such as an O-ring seal 171, a quad ring or square cross-section seal, a gasket, or the like, positioned therein. When positioned on the extension tube 155, an inner surface of the O-ring seal 171 or like friction device contacts the extension tube 155 to create friction and retain the volume spacer 162 on the extension tube 155. Thus, a friction fit between the extension tube 155 and the one or more volume spacers 162 can be created. The placement of one or more volume spacers 162 allows for customization of the spring rate and progression of the air-spring assembly 124.

In some embodiments, the volume spacers 162 do not include friction devices and instead can be retained on the extension tube 155 via an interference fit. To this end, the volume spacers 162 can have inner diameters configured to provide an interference fit between the volume spacers 162 and the extension tube 155. In some embodiments, the volume spacers 162 can be retained on the extension tube 155 by a retaining ring device (e.g., a wire ring or a snap ring, or the like) positioned on an upper end of the extension tube 155 and above an uppermost one of the volume spacers 162.

The volume spacers 162 can include minimum inner diameter and outer diameter clearances to the lower tube 106b and the extension tube 155 to provide a close clearance, such that a majority of air cylinder oil bath rests on top of the volume spacer 162 and such that the bath oil is available to easily splash upward on to interior of the lower tube 106b and air piston seal when the inverted suspension fork 100 and the vehicle go through bumps or other agitation. To this end, the volume spacers 162 can include an outer diameter that closely conforms to an inner diameter of the cylinder defined by inner walls of the lower tube 106b.

A cylinder cap 172 can be positioned at a bottom end of the cylinder of the lower tube 106b in some embodiments. The cylinder cap 172 can be threaded on the cylinder to form a threaded connection and such that the cylinder cap 172 can be removed to open the cylinder. It is understood, however, that other connection types other than threaded connections can be formed. A cylinder cap seal 175 can be positioned between the cylinder cap 172 and the cylinder to prevent air or oil leakage. The air cap 152 can detachably attach to the cylinder cap 172. The cylinder cap 172 can be removed using a tool such as a Shimano tool or similar tool.

The cylinder cap 172 may be nested within a bottom or lower portion of the cylinder such that a low-profile cap is achieved. When adjustments to the air spring characteristics are desired, the operator may unscrew or otherwise detach the cylinder cap 172 from the cylinder. This may create an opening through which one or more volume spacers 162 can be inserted into or removed from the cylinder. Bath oil can also be positioned in the cylinder. After the desired configuration of volume spacers 162 and/or bath oil is achieved, the cylinder cap 172 may be reattached to the lower end of the cylinder, sealing the system and restoring its functionality.

In some implementations, the extension tube 155 may be integral with the cylinder cap 172, forming a single unit. This configuration may be achieved through a threaded connection or as a single-piece construction, which may simplify the assembly process and reduce the risk of air or oil leakage from the system.

To adjust the number of volume spacers 162, an operator may first remove the air cap 152. The air cap 152 may include finger ribs or a textured surface to facilitate easy removal by hand. After removing the air cap 152, the operator may release the air pressure from the system using the air inlet 148 (e.g., by pressing it with a fingernail, using a pump, etc.).

Once the air pressure is fully released, a tool (e.g., a Shimano tool) may be used to remove the cylinder cap 172. With the cylinder cap 172 removed, the operator may access the stack of volume spacers 162 positioned on the extension tube 155. At this point, volume spacers 162 may be added or removed from the stack to achieve the desired air spring characteristics, allowing for customization of the suspension performance to suit individual preferences or riding conditions. The volume spacers 162 via the O-rings 171 may stick or otherwise retain to the extension tube 155 to facilitate reinstallation of the extension tube and the cylinder cap 172.

In embodiments in which 12 cc of bath oil is used as but one example, the extension tube 155 may have a height along the longitudinal axis such that the air exit aperture 158 is above the 12 cc of bath oil (e.g., a resting bath oil height) and above a stacked height of eight volume spacers 162. Other amounts of bath oil and/or volume spacers 162 can be implemented in various embodiments, as can be appreciated.

The air inlet 148 can be disposed within the hollow body of the extension tube 155 in some embodiments. In some implementations, the air inlet 148 can incorporate a Schrader valve or other pneumatic valve. To access the air inlet 148, an operator may unscrew or otherwise detach the air cap 152 from the lower end of the cylinder. Once removed, the air cap 152 exposes the air valve, allowing for pressure adjustments. The operator may then attach a compatible pump, such as a hand-operated bicycle pump or a digital pressure gauge with inflation capabilities, directly to the air valve.

The pump can include a threaded chuck that can be securely fastened onto the exposed valve stem, creating an airtight seal. This can permit the operator to add or remove air from the air-spring assembly 124, fine-tuning the suspension characteristics to match their preferences or riding conditions. After making the desired adjustments, the pump can be detached, and the air cap 152 can be reattached to protect the air inlet 148 during normal operation of the inverted suspension fork 100. During operation of a vehicle, the movement and vibrations can cause the bath oil to splash and agitate within the cylinder, lubricating various internal components while the positioning of the air exit aperture 158 above the maximum oil level may prevent the oil from entering the interior of the extension tube 155.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An inverted suspension fork for a vehicle, comprising:
a first upper tube and a second upper tube;
a first lower tube slidably engaged with the first upper tube and a second lower tube slidably engaged with the second upper tube; and
an air spring assembly disposed within one of the first lower tube and the second lower tube, the air spring assembly comprising:
a piston;
an air inlet positioned on a lower end of the lower tube;
an extension tube in communication with the air inlet; and
at least one air exit aperture positioned in an upper end of the extension tube.

2. The inverted suspension fork according to claim 1, wherein the at least one air exit aperture is cross-drilled substantially perpendicular to a longitudinal axis of the extension tube.

3. The inverted suspension fork according to claim 1, further comprising bath oil positioned within at least one of the first lower tube and the second lower tube, wherein the air exit aperture is positioned above the bath oil.

4. The inverted suspension fork according to claim 1, wherein the at least one air exit aperture is positioned at a top surface of the extension tube along a longitudinal axis of the extension tube.

5. The inverted suspension fork according to claim 1, further comprising at least one volume spacer having an aperture, the extension tube being positioned through the aperture.

6. The inverted suspension fork according to claim 1, wherein the at least one air exit aperture is positioned in the annular wall of the extension tube.

7. The inverted suspension fork according to claim 5, wherein the at least one volume spacer comprises a friction device positioned around the aperture that forms a friction connection with the extension tube.

8. The inverted suspension fork according to claim 5, wherein the at least one volume spacer comprises an inner diameter configured to provide an interference fit between the at least one volume spacer and the extension tube.

9. A suspension system, comprising:
an upper tube;
a lower tube slidably engaged with the upper tube configured to contain bath oil; and
an air spring assembly disposed within the lower tube, the air spring assembly comprising:
an air piston;
an air inlet positioned on a lower end of the lower tube;
an extension tube in communication with the air inlet; and
at least one air exit aperture positioned on the extension tube at a location above a maximum fill amount of the bath oil.

10. The suspension system according to claim 9, further comprising at least one volume spacer sized and positioned to closely conform to inner surfaces of the lower tube, the volume spacer having an aperture, the extension tube being positioned through the aperture.

11. The suspension system according to claim 10, further comprising at least one volume spacer comprising a friction device positioned around the aperture that forms a friction connection with the extension tube.

12. The suspension system according to claim 9, wherein the at least one air exit aperture of the extension tube is positioned in the annular wall of the extension tube.

13. The suspension system according to claim 9, wherein the at least one air exit aperture of the extension tube is positioned substantially perpendicular to a longitudinal axis of the extension tube.

14. The suspension system according to claim 9, wherein the at least one air exit aperture of the extension tube is positioned at a top surface of the extension tube along a longitudinal axis of the extension tube.

15. The suspension system according to claim 10, further comprising a friction device positioned on an upper end of extension tube, the friction device being configured to retain the at least one volume spacer on the extension tube.

16. The suspension system according to claim 9, wherein the upper tube and the lower tube are part of an inverted fork for a vehicle.

17. A suspension system, comprising:
an upper tube;
a lower tube slidably engaged with the upper tube, the lower tube comprising bath oil; and
an air spring assembly disposed within the lower tube, the air spring assembly comprising:
an air piston defining a positive air chamber and a negative air chamber;
an air inlet positioned on a lower end of the lower tube; and
an extension tube comprising at least one air exit aperture, wherein the extension tube is in communication with the air inlet and with the positive air chamber, wherein the air exit aperture is configured to reduce a loss of the bath oil from the lower tube through the extension tube.

18. The suspension system according to claim 17, wherein the extension tube comprises at least one air exit aperture positioned at a location above a maximum fill amount of the bath oil.

19. The suspension system according to claim 17, wherein at least one air exit aperture formed in the annular wall of the extension tube.

20. The suspension system according to claim 17, further comprising at least one volume spacer comprising an aperture, wherein the extension tube is positioned within the aperture.
